(19) United States
(12) Patent Application Publication
(10) Pub. No.: US 2015/0063907 A1
(43) Pub. Date: Mar. 5, 2015

(54) Advanced Paver/Screed Automation and Controls

(71) Applicant: Caterpillar Paving Products, Inc., Minneapolis, MN (US)

(72) Inventors: Luke E. Graham, Maple Grove, MN (US); Toby A. Frelich, Saint Michael, MN (US); Jameson M. Smieja, Mound, MN (US); Rick L. Mings, Andover, MN (US)

(73) Assignee: Caterpillar Paving Products, Inc., Minneapolis, MN (US)

(21) Appl. No.: 14/017,640

(22) Filed: Sep. 4, 2013

(51) Int. Cl. E01C 19/00; G06F 3/0482; G06F 3/0484; E01C 19/48; E01C 19/22

(52) U.S. Cl. CPC E01C 19/004; E01C 19/48; E01C 19/22; G06F 3/04842; G06F 3/0482
USPC 404/84.1; 404/84.05; 715/745

(57) ABSTRACT

A method of operating a machine having at least one tool is provided. The method may store one or more job profiles or machine configurations and an auto-zero or default profile in a memory associated with the machine, where each of the job profiles and the auto-zero profile may include one or more control settings for operating one or more of the machine and the tool; recall a selected one of the job profiles and the auto-zero profile in response to user input received at a user interface associated with the machine; engage or machine reset operation of one or more of the machine and the tool according to the control settings associated with the selected one of the job profiles and the auto-zero profile; and disengage at least part of the operation based on positioning information provided by one or more feedback devices.

### TECHNICAL FIELD

The present disclosure relates generally to paving machines, and more particularly, to systems and methods for facilitating automated control of paving machines and screed assemblies associated therewith.

### BACKGROUND

Paving machines are used to apply paving material relatively evenly over a desired surface. These machines are regularly used in the construction of roads, parking lots and other areas where a smooth durable surface is desired. Laying paving material entails spreading paving material consisting of an aggregate filled bituminous mixture on a prepared roadbed. The paving material is spread while hot and is then compacted so that a hardened pavement surface is formed upon cooling. Conventional paving machines employ an assembly termed a screed that is generally drawn behind the paving machine. The screed assembly includes a replaceable screed plate that is constructed of a suitable steel to spread a smooth, even layer of paving material on the prepared roadbed. The weight of the screed assembly aids in compressing the paving material and performing initial compaction of the paving material layer. Screed assemblies can also include vibratory mechanisms placed directly on the screed plate or separate vibratory tamper bars connected in tandem with the screed plate to aid in the initial compaction of the paving material.

Proper operation of a conventional paving machine demands the appropriate adjustment or control of several different machine and tool settings. Moreover, control settings for a particular paving application at one jobsite may not be applicable to attributes of another application at another jobsite. For instance, differences in the dimensions, grade, and type of the roadbed, among other factors, may require different screed heights, screed widths, vibrational frequencies, pave speeds, tamper frequencies, and the like. Thus, for each new jobsite or for each new application, an operator of a paving machine may need to readjust the control settings, which can be tedious, time consuming, as well as prone to misconfigurations and reduced paving quality. Such drawbacks are further multiplied if there is more than one operator using the same paving machine.

In an effort to alleviate some of these drawbacks, some paving machines employ systems which enable custom control settings derived from data collected and archived from previous applications. One such system is provided for example in EP 1 544 354 issued to Vögele in which the operator may gain quicker access to settings for a particular application, and thereby, minimize the overall time spent paving work. However, these systems still lack versatility and fail to provide the operator with a more intuitive approach to operating or configuring a paving machine. More specifically, these paving machines do not provide automated functions for storing, recalling, and setting machine and/or tool settings according to different job profiles, different jobsites or different desired machine configurations. Furthermore, these paving machines do not provide the operator with a means to re-zero or to automatically reset the machine and/or tool settings to default settings.

The present disclosure is directed at addressing one or more of the deficiencies set forth above.

### SUMMARY OF THE DISCLOSURE

In one aspect of the present disclosure, a method of operating a paving machine having at least one tool is provided. The method may comprising the steps of storing one or more job profiles and an auto-zero profile in a memory associated with the paving machine, each of the job profiles and the auto-zero profile having one or more control settings for operating one or more of the paving machine and the tool; recalling a selected one of the job profiles and the auto-zero profile in response to user input received at a user interface associated with the paving machine; engaging operation of one or more of the paving machine and the tool according to the control settings associated with the selected one of the job profiles and the auto-zero profile; and disengaging at least part of the operation based on positioning information provided by one or more feedback devices.

In another aspect of the present disclosure, a paving machine having a screed assembly is provided. The paving machine may include a user interface, one or more feedback devices coupled to one or more of the paving machine and the screed assembly, and a controller in electrical communication with the user interface and the feedback devices. The controller may be configured to store one or more job profiles in a memory associated with the paving machine, where each of the job profiles may have one or more control settings for operating one or more of the paving machine and the screed assembly. The controller may further be configured to recall a selected one of the job profiles in response to user input received at the user interface associated with the paving machine, and engage operation of one or more of the paving machine and the screed assembly according to the control settings associated with the selected one of the job profiles.

In yet another aspect of the present disclosure, a paving machine is provided. The paving machine may include a screed assembly, a user interface having at least one input device and at least one display device for operating the paving machine and the screed assembly, one or more feedback devices coupled to the paving machine and the screed assembly configured to detect positioning information of one or more of the paving machine and the screed assembly, a memory for retrievably storing one or more job profiles and an auto-zero profile where each of the job profiles and the auto-zero profile may have one or more control settings for operating one or more of the paving machine and the screed assembly, and a controller in electrical communication with each of the paving machine, the screed assembly, the user interface, the feedback devices, and the memory. The controller may be configured to assign one or more of the control settings to one of the job profiles based on user input received through the input device of the user interface, recall a selected one of the job profiles and the auto-zero profile based on user input received through the input device of the user interface, engage operation of one or more of the paving machine and the screed assembly according to the control settings associated with the selected one of the job profiles and the auto-zero profile, and disengage at least part of the operation based on the positioning information provided by the feedback devices.

### BRIEF DESCRIPTION OF THE DRAWINGS

FIG. 1 is a diagrammatic view of one exemplary paving machine with a screed assembly;

FIG. 2 is an illustrative view of one exemplary user interface for a paving machine;

FIG. 3 is a schematic view of one exemplary control system for a paving machine of the present disclosure;

FIG. 4 is a diagrammatic view of one exemplary algorithm or method of operating a paving machine;

FIG. 5 is an illustrative view of one exemplary menu provided by a user interface of the present disclosure; and

FIG. 6 is an illustrative view of one exemplary submenu provided by a user interface of the present disclosure.

### DETAILED DESCRIPTION

Reference will now be made in detail to specific embodiments or features, examples of which are illustrated in the accompanying drawings. Generally, corresponding reference numbers will be used throughout the drawings to refer to the same or corresponding parts.

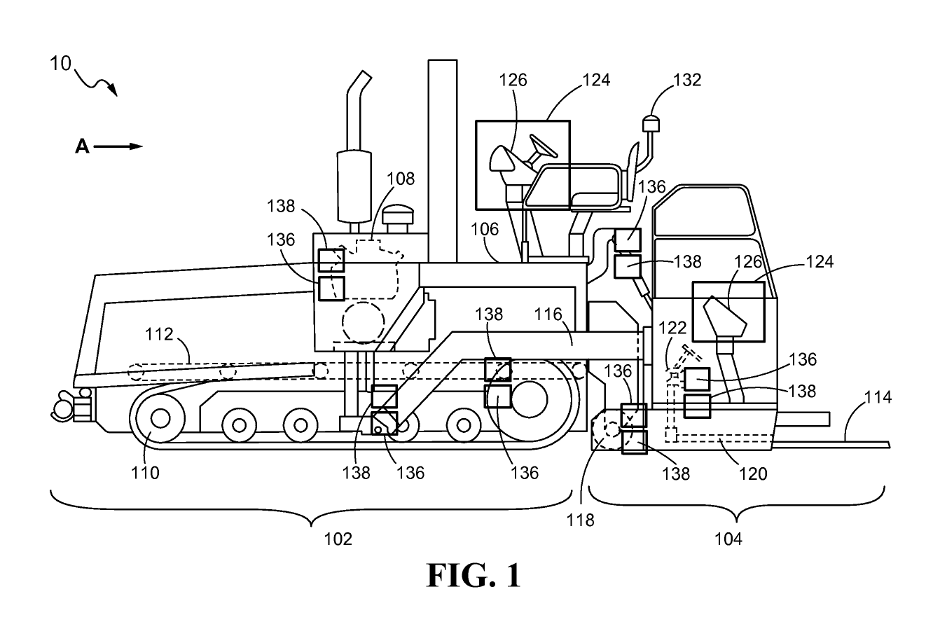

Referring to FIG. 1, one exemplary embodiment of a machine 100, such as a paving machine which may employ an advanced paver or screed automation method and/or controls therefor, is provided. As shown, the paving machine 100 may generally comprise of a tractor section 102 and a screed section 104. The tractor section 102 may include a chassis or machine frame 106 to which a prime mover 108 and one or more traction devices 110 may be coupled. The prime mover 108 may include, for example, a diesel engine, a gasoline engine, a natural gas engine, or any other type of combustion engine commonly used for generating power. The traction devices 110 may include one or more driven tracks, wheels, or any other suitable propulsion mechanisms for causing movement in conjunction with the prime mover 108.

The paving machine 100 of FIG. 1 may further include a feed assembly 112 for conveying paving material 114, such as asphalt, or the like, in a rearward manner relative to the paving machine 100. The screed section 104 may be towed or otherwise coupled to the tractor section 102, for instance, by a pair of tow arms 116, or the like. More particularly, the feed assembly 112 may be configured to move paving material 114 rearwardly in the direction denoted by arrow A and towards the screed section 104. The screed section 104 of the paving machine 100 may additionally include an auger assembly 118 configured to laterally and more evenly spread the paving material 114 along the width of the screed section 104. As shown, the screed section 104 may also include a screed plate 120 as well as a tamper bar mechanism 122 disposed between the feed assembly 112 and the screed plate 120. The tamper bar mechanism 122 may be used to pre-compact the paving material 114 as the paving machine 100 moves forward, or in the direction opposite the direction denoted by arrow A, while the screed section 104 may be used to remove air pockets and other voids from the paving material 114 to create a flat, paved surface.

Among other things, the paving machine 100, as well as one or more of the tools thereof, such as the screed section 104, or the like, may be controlled by an operator or a user via a control system 124 of the machine 100, access to which may be provided via one or more user interfaces 126 that are provided on one or more locations of the machine 100. For example, while a user interface 126 may be provided at the tractor section 102, the user interface 126 may additionally or alternatively be provided on other locations of the paving machine 100, such as at the screed section 104 thereof as shown in FIG. 1. Furthermore, the control system 124 may be configured such that the user interface 126 disposed at the tractor section 102 provides user access to tractor controls, and the user interface 126 disposed at the screed section 104 provides user access to screed controls. In other embodiments, the control system 124 may be configured such that each user interface 126 provides access to essentially the same machine controls, including at least partial control of the tractor section 102 as well as the screed section 104. Still further configurations or modifications are possible and will be apparent to those skilled in the art without departing from the scope of the appended claims.

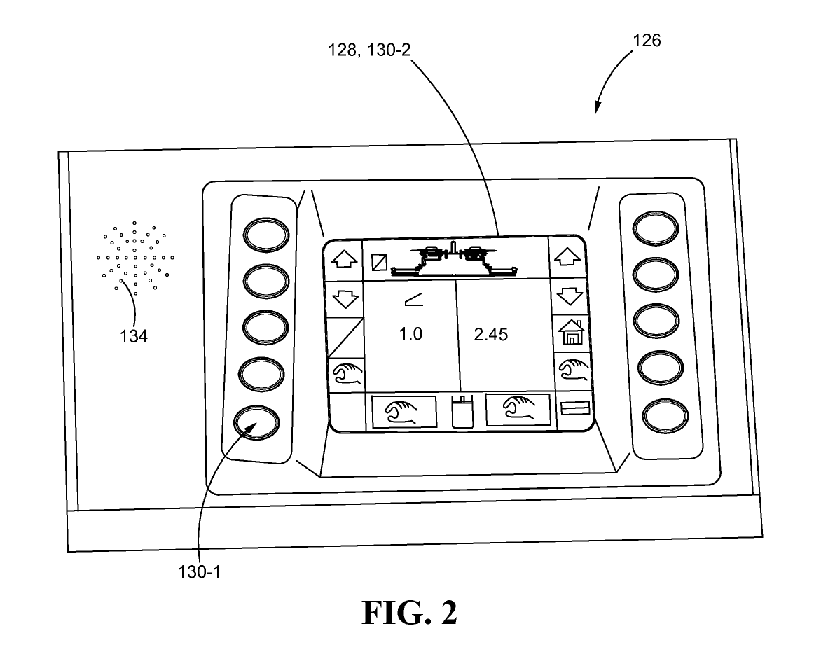

Each user interface 126 of the paving machine 100 of FIG. 1 may employ any combination of devices suitable for providing machine feedback to the user and for enabling user access to controls therefor. As shown in FIG. 2 for example, the user interface 126 may include one or more output devices 128 capable of communicating to the user any one or more of general operating conditions or states, control parameters, machine settings, sensed data, and any other information relevant to the paving machine 100 and/or screed section 104 thereof. The user interface 126 may also include one or more input devices 130 capable of receiving from the user any combination of general operating conditions or states, control parameters, machine settings, sensed data, and the like. The output device 128 may employ any combination of visual displays including monitors, display screens, lighting devices, such as strobe lights or beacons 132, light emitting diodes (LEDs), and the like. The output device 128 may also employ audio devices, such as speakers 134, and the like. The input device 130 may employ any one or more of buttons 130-1, switches, dials, knobs, joysticks, handles, touchpads, and the like. In further modifications, the user interface 126 may employ touchscreen displays 130-2 simultaneously serving as both output and input devices 128, 130.

Effective control of the individual components of the paving machine 100 and/or the screed assembly 104 may generally be enabled using a combination of means for executing operations, or causing mechanical and/or electrical adjustments of the components, and means for monitoring the state or condition of the components. More specifically, for each component of the paving machine 100 and/or screed assembly 104 that is adjusted by the user, the control system 124 may electrically communicate with one or more actuating devices 136 capable of executing the adjustment, as well as one or more feedback devices 138 capable of tracking the progress, completion, and/or accuracy of the adjustment. For example, the actuating devices 136 may be provided in association with each adjustable component throughout the tractor section 102 and/or the screed section 104, and may employ any one or more of hydraulic systems, pneumatic systems, electrical systems, mechanical systems, geared systems, and the like, to effectuate a desired operation or adjustment. Correspondingly, the feedback devices 138 may also be provided in association with each adjustable component, and may employ any one or more of in-cylinder position sensors, linear variable displacement transducers, rotary sensors, switches, laser systems, sonic sensors, radar, encoders, and the like, to track the adjustment.

Among other things, each of the feedback devices 138 may be configured to detect or collect data pertaining to parameters, such as net displacement, position, velocity, orientation, or any other state or condition of the component with which it is associated. In a paving machine 100, for instance, the feedback devices 138 may be used to track the position or other relevant parameters of the screed extender, height system, crown, tow points, augers, or any other component thereof. The data provided by the feedback devices 138 may be communicated in analog, digital, or in other forms of electronic signals from which the control system 124 may be able to derive actual values corresponding to the net displacement, position, velocity, orientation, or the like, of a machine or tool component. Additionally, the feedback devices 138 may be configured to electrically communicate such detected parameters to the control system 124 continuously, periodically, in response to an internal request, or the like. Furthermore, in addition to tracking the progress, completion and/or accuracy of an executed adjustment, the control system 124 may also be configured to refer to one or more of the feedback devices 138 to determine a base reference or starting point from which to gauge any future adjustments that may be requested by the user. The control system 124 may also refer to the feedback devices 138 in determining when to terminate an automated adjustment, such as during a preprogrammed reset process, or the like. Still further, the control system 124 may refer to data collected by the feedback devices 138 in order to track the accuracy of live operations in relation to preprogrammed algorithms, constraints, rule sets, control maps, or the like.

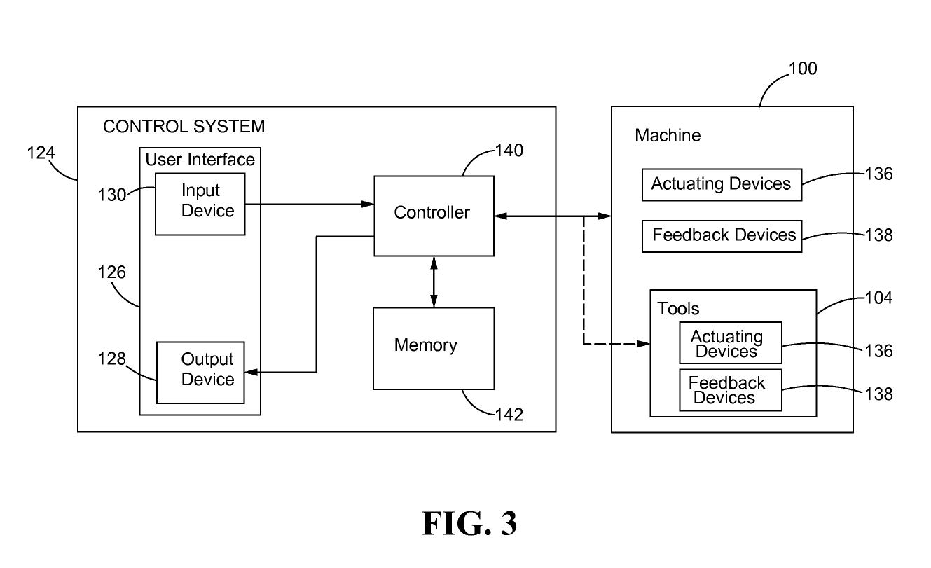

Turning to FIG. 3, one exemplary embodiment of the control system 124 of the paving machine 100 of FIG. 1 is provided. As shown, the control system 124 may generally include at least one user interface 126, a controller 140 and a memory 142, which mainly serves to process and communicate information between the user and the machine 100. As discussed with respect to FIGS. 1 and 2, the user interface 126 may include at least one output device 128 through which the user may observe certain operating parameters, conditions, settings, and any other information relevant to the machine 100 and/or screed section or assembly 104 associated therewith, as well as at least one input device 130 through which the user may input certain operator commands to the machine 100 and/or the associated screed section 104. The controller 140 may be implemented using any one or more of a processor, a microprocessor, a microcontroller, an electronic control module (ECM), an electronic control unit (ECU), or any other suitable means for managing electronic control between the user interface 126 of the control system 124, the paving machine 100 and the associated screed section 104. Although the memory 142 in FIG. 3 is depicted as being separate from the controller 140, it will be understood that the memory 142 may alternatively be external relative to the control system 124, removably coupled to the controller 140, and/or provided on-board or within the controller 140.

Through the control system 124, the operator or user may be able to monitor as well as control various parameters or control settings of the paving machine 100 and/or the associated screed assembly 104. More particularly, the control system 124 may enable the user to save optimum control settings for a given jobsite such that those control settings can be later recalled and automatically applied at another jobsite with similar characteristics. The control system 124 may further enable the user to automatically re-zero, or restore to default, one or more control settings of the machine 100 and/or the screed assembly 104 as desired. Moreover, the controller 140 may be capable of monitoring or detecting the current control settings of the paving machine 100 and/or the screed assembly 104 by communicating with one or more of the feedback devices 138, for example, as discussed in relation to the embodiment of FIG. 1. Any combination of the detected control settings may further be stored in memory 142, for example, to be later used as a reference point for determining net displacement, or to be later recalled and used as a preset configuration. The controller 140 may also be capable of executing an adjustment of a component of the machine 100 and/or screed assembly 104, for instance, in response to user input and/or in accordance with an automated machine reset process, or any other preprogrammed process, by electrically engaging one or more of the actuating devices 136 as discussed in relation to the embodiment of FIG. 1.

Correspondingly, the controller 140 of the control system 124 of FIGS. 1 and 3, for example, may be configured to operate according to predetermined algorithms or sets of instructions which program the controller 140 to translate certain user input or commands received at the user interface 126 into corresponding preset mechanical adjustments of the tractor section 102 and/or the screed section 104. Such algorithms or sets of instructions and conditionals may be preprogrammed or incorporated into the memory 142 of the control system 124, into a memory of the controller 140, or any other memory that is accessible by the controller 140 by means commonly known in the art.

### INDUSTRIAL APPLICABILITY

In general, the present disclosure sets forth systems and methods for providing automated operation of a paving machine and a screed assembly associated therewith. The present disclosure, however, may also find utility in paving applications involving other paving tools or operations that can benefit from automating complex machine and tool setups using preprogrammed and user-defined control settings. The disclosed systems and methods may be used to facilitate operations of paving machines that are frequently shared between different operators or users, and minimize the overall time required to setup or calibrate the paving machine and its associated tools for each new task or jobsite. The present disclosure serves to substantially shorten the downtime, reduce operator errors and improve overall machine performance and quality by providing user access to a library of retrievable job profiles having control settings that are optimized for different types of jobsites, as discussed more specifically below.

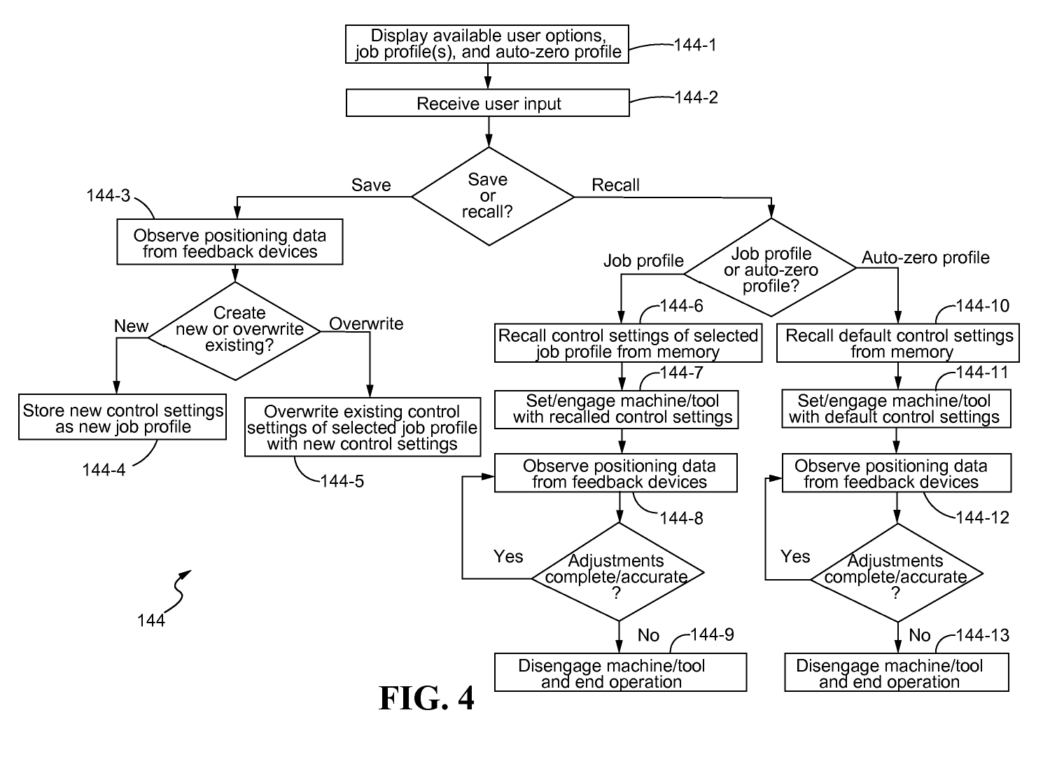

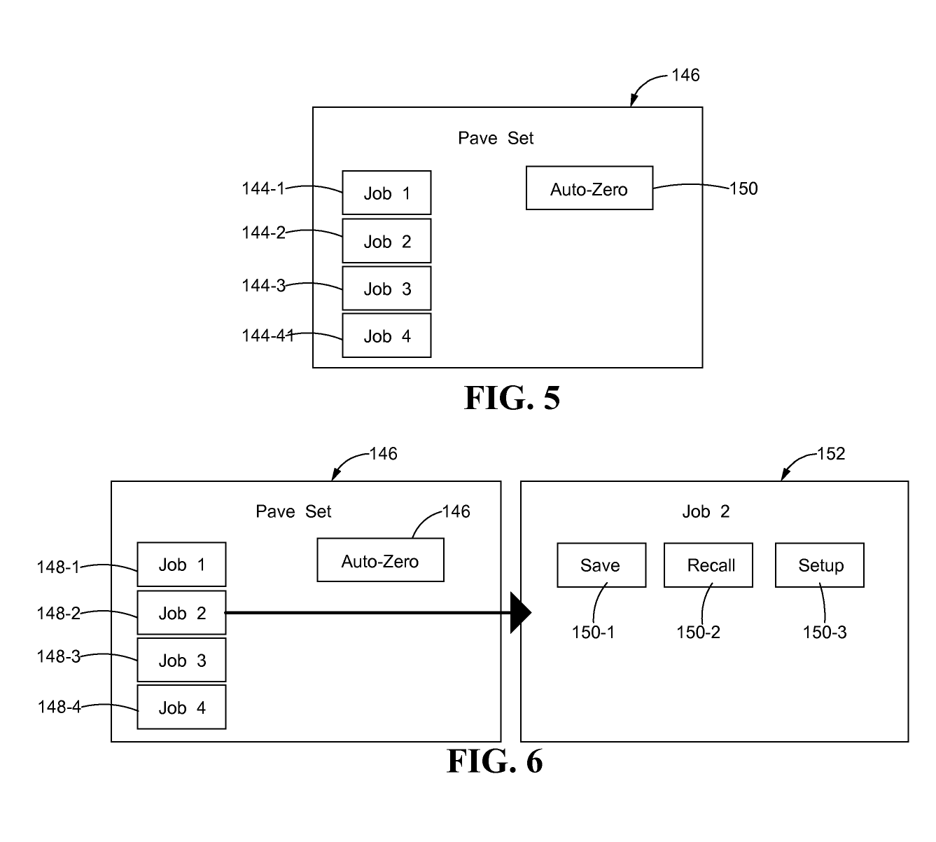

Referring now to FIG. 4, one such exemplary algorithm or method 144 for operating the controller 140 is diagrammatically provided. As shown, the controller 140 in step 144-1 may be configured to initially display a menu, for example, the menu 146 shown in FIG. 5, to the user providing available options for controlling the machine 100 and/or screed assembly 104. The user may trigger the menu 146 via the input device 130, for example, using designated buttons or graphic icons displayed within the user interface 126 of FIG. 2. The menu 146 may be presented to the user via the output device 128 of the user interface 126, such as the display screen of FIG. 2. In addition, the menu options displayed may be configured to be specific to only the tractor section 102 of the machine 100, specific to only the screed section 104 of the machine 100, or a combination of both. Furthermore, the menu 146 may display one or more selectable job profiles 148 and at least one selectable auto-zero/machine default profile 150. Moreover, the job profiles 148 may correspond to different groups of control settings that have been previously stored for different categories of jobsites, while the machine default profile 150 may correspond to one or more default control settings which zeros or resets the machine 100 and/or the screed assembly 104 controls to default or otherwise predefined basic settings.

Still referring to FIG. 5, each job profile 148 may correspond to a different combination of control settings configured to provide efficient and optimum machine performance for the particular characteristics of a given jobsite. For example, job profile 148-1 may be best suited for jobsites having one set of characteristics, while job profile 148-2 may be best suited for jobsites having another contrasting set of characteristics, and so forth. The jobsite characteristics to which each job profile 148 is assigned may be designated by the user and provide consideration for a variety of different factors including roadbed or surface attributes, dimensions, grade, accessibility, and any other characteristic of the jobsite that may be relevant to the operation of the machine 100 and/or the screed assembly 104 thereof. Moreover, through the menu 146 provided, the user may be able to save or create new control settings and associated job profiles 148, as well as recall previously stored control settings and job profiles 148. Using the menu 146, the user may also be able to modify one or more of the control settings already assigned to the job profiles 148 and/or overwrite existing job profiles 148 as desired. In further modifications, the user may also be able to save new default control settings, edit existing default control settings, as well as recall existing default settings associated with the auto-zero profile 150.

Referring back to FIG. 4, the controller 140 in step 144-2 may be configured to standby and communicate with the user interface 126 to receive any input or instructions from the user. More specifically, the user may be able to make a selection of one or more menu options using any one or more of the input devices 130 associated with the user interfaces 126 of FIGS. 2 and 3. For example, on user interfaces 126 having buttons 130-1, or the like, the user may select a menu option by physically pressing the button 130-1 corresponding to the action desired by the user. Additionally or alternatively, on user interfaces 126 having touchscreen enabled input devices 130-2, the user may select a menu option by touching or applying other gestures relative to one or more graphic icons presented within the display corresponding to the desired action. Once a selection is made, one or more electronic signals corresponding to the user's selection may be communicated from the input device 130 of the user interface 126 to the controller 140. Based on the information communicated, the controller 140 may be able to determine the action desired by the user, and further, determine the next appropriate task or operation to perform according to the method or algorithm 144 programmed therein.

As shown in FIG. 6, if the user selects job profile 148-2 from the menu 146 provided, the controller 140 may be configured to present a submenu 152 which provides the user with further options 154, for example, options to Save 154-1, Recall 154-2 or Setup 154-3 one or more of the control settings associated with the selected job profile 148-2. Furthermore, based on interactions between the user and the submenu 152 provided, the controller 140 may be able to determine whether to save and assign new control settings to the selected job profile 148-2 according to the Save option 154-1, recall previously saved control settings already assigned to the selected job profile 148-2 according to the Recall option 154-2, or enable manual setup of the control settings associated with the selected job profile 148-2 according to the Setup option 154-3. Alternatively, the user may also exit the submenu 152 without selecting any of the available options 154, for example, by pressing the appropriate buttons 130-1, or if available, by applying the appropriate gestures via a touchscreen display 130-2.

If the user selects the Save option 154-1 from the submenu 152, the controller 140 may be configured to determine whether the control settings currently in force should be saved as new settings or whether the settings should overwrite existing control settings associated with the selected job profile 148-2. More specifically, the controller 140 in step 144-3 may be configured to first communicate with one or more of the feedback devices 138 associated with the paving machine 100 and/or screed assembly 104 to observe current positioning information detected thereby. The positioning information detected and output by each feedback device 138 may pertain to the net displacement, relative proximity, orientation, velocity, or any other state or condition of the component with which it is associated. Based on the positioning information, the controller 140 may be able to derive the corresponding combination of control settings to be saved, and if so desired, to be later recalled to restore the paving machine 100 and/or screed assembly 104 to the current configuration. The control settings of a given job profile 148 may correspond to settings or parameters for controlling the associated paving machine 100 and/or screed assembly 104, and may relate to any one or more of screed height, screed width, conveyor mix height, auger mix height, auger height, tamper speed, tamper ramp rate, tamper speed ratio, vibrational frequency, pave speed, wheel assist mode, wheel assist pressure, screed assist mode, screed assist pressure, screed lower lock and halt modes, screed heat temperature, extender width, tow-point position, crown position, extender height, extender slope, and the like. It will be understood that in other modifications, or in conjunction with other machine-tool combinations adapted for other applications, the control settings may further relate to other operating conditions and machine parameters.

Once positioning information is obtained in step 144-3, the controller 140 may determine whether the selected job profile 148-2 is currently associated with any other set of control settings previously stored in the associated memory 142. If no such prior control settings are found in memory 142, the controller 140 in step 144-4 may be configured to store the current control settings as new settings to be associated with the desired job profile 148-2. If, however, the memory 142 contains any previously stored control settings, the controller 140 in step 144-5 may be configured to overwrite the existing data and associate the new control settings with the selected job profile 148-2. In further modifications, the controller 140 may be configured to first prompt the user with a warning indicating and requesting acknowledgement that any control settings previously stored under the selected job profile 148-2 will be overwritten by the new control settings. Once the new control settings have been stored in memory 142 and properly associated with the selected job profile 148-2, the controller 140 may be configured to notify the user that the settings have been successfully saved and await further input from the user. Alternatively, the controller 140 may be configured to automatically exit the submenu 152, and return to the main menu 146, of FIG. 5 for example, to standby for further input from the user.

If the user selects the Recall option 154-2 during step 144-2, the controller 140 may proceed to recall the control settings currently associated with the selected job profile 148-2 according to step 144-6 of FIG. 4. More specifically, the controller 140 may be configured to access the memory 142 to retrieve data pertaining to any one or more of the control settings previously stored and designated under job profile 148-2. Once the controls settings are retrieved from memory 142, the controller 140 may be configured to automatically set and engage the paving machine 100 and/or the screed assembly 104 according to the recalled control settings in step 144-7. Alternatively, the controller 140 may prompt the user and request confirmation prior to setting and engaging the machine 100 to provide the user with an opportunity to cancel the operation for any reason. The controller 140 may additionally provide safety warning messages to the user to ensure that the machine 100 and/or the screed assembly 104 are clear for movement prior to any actual engagement thereof. Once the machine 100 and/or screed assembly 104 has been engaged, the controller 140 may further be configured to automatically activate any one or more of the output devices 128 of the user interface 126 so as to alert and caution others within the vicinity of the machine 100 of active movement. For example, the controller 140 may activate the strobe light 132 to blink, activate speakers 134 to sound an audible alarm, activate the display screen 128 of the user interface 126 to blink, and/or activate any other peripheral of the machine 100 to signify active movement.

Once the machine 100 and/or screed assembly 104 has been engaged and while adjustments are being performed, the controller 140 may further be configured to observe or monitor various positioning information collected by the one or more feedback devices 138 in step 144-8. More specifically, the controller 140 may observe the actual position of any one or more components of the machine 100 and/or screed assembly 104 as detected by one or more of the feedback devices 138, and compare the actual position with the desired position, or the position corresponding to the selected job profile 148-2 and desired by the user. The controller 140 may perform such comparisons per iteration for any number of cycles until a substantial agreement between the actual position and the desired position is found. If such a substantial agreement is observed between the actual position and the desired position, the controller 140 may be configured to disengage and end the adjustment of the one or more components of the paving machine 100 and/or screed assembly 104 in step 144-9. Moreover, by observing actual positioning feedback and using the feedback data as a reference, the controller 140 may be able to perform any number of adjustments to the machine 100 and/or screed assembly 104 in substantially less time and with increased accuracy.

If the user selects the Setup option 154-3 during step 144-2, the controller 140 may prompt the user to manually enter one or more parameters of the paving machine 100 and/or screed assembly 104 or control settings therefor. For example, the controller 140 may be configured to prompt the user to manually enter any one or more of screed heat temperature, desired paving depth, desired paving width, extender slope, desired crown, tamper speed, vibration frequency, paving speed, or any other parameter or control setting relevant to the operation of the paving machine 100 and associated screed assembly 104. The controller 140 may prompt the user for each parameter or control setting via, for example, the touchscreen 130-2 of FIG. 2, or any other suitable output device 128 associated with the user interface 126. The controller 140 may also enable the user to input the relevant entries using any one or more of the buttons 130-1, the touchscreen 130-2, or any other suitable input device 130 of the user interface 126. Once all required fields have been entered, the controller 140 may prompt the user with a preview screen to confirm the control settings, and subsequently, save the entries within memory 142 for later retrieval in accordance with steps 144-4 and 144-5. In other embodiments, or in conjunction with other machine-tool combinations adapted for other applications, it will be understood that the Setup option 154-3 may also cause the controller 140 to prompt the user for other types of input, control settings and parameters.

If the user selects the auto-zero profile 150 from the main menu 146 rather than any of the available job profiles 148 during step 144-2, the controller 140 may automatically recall any one or more of the control settings currently stored and associated with the auto-zero profile in step 144-10. Similar to the Recall option 154-2 from the submenu 152 of FIG. 6 for instance, the controller 140 may be configured to access the memory 142 to retrieve data pertaining to any one or more of the control settings previously stored or preprogrammed in association with the auto-zero profile 150. As with each job profile 148, the control settings associated with the auto-zero profile 150 may correspond to settings or parameters for controlling the associated paving machine 100 and/or screed assembly 104, and relate to any one or more of screed height, screed width, conveyor mix height, auger mix height, auger height, tamper speed, tamper ramp rate, tamper speed ratio, vibrational frequency, pave speed, wheel assist mode, wheel assist pressure, screed assist mode, screed assist pressure, screed lower lock and halt modes, screed heat temperature, extender width, tow-point position, crown position, extender height, extender slope, and the like. In contrast to job profiles 148, however, the control settings of the auto-zero profile 150 may correspond to predefined default control settings which may serve to restore the paving machine 100 and/or the screed assembly 104 to base or factory settings. Furthermore, while the controller 140 may be configured to bypass intermediate menus, such as the submenu 152 of FIG. 6, the controller 140 may alternatively be configured to provide menus and options similar to those associated with each of the job profiles 148 so as to enable further customization of the auto-zero profile 150.

Similar to the Recall option 154-2 for job profiles 148, once the default controls settings associated with the auto-zero profile 150 are retrieved from memory 142, the controller 140 may be configured to automatically set and engage the paving machine 100 and/or the screed assembly 104 according to the auto-zero profile 150 in step 144-11. The controller 140 may alternatively be configured to prompt the user and request confirmation prior to setting and engaging the machine 100 and/or the screed assembly 104 to provide the user with an opportunity to cancel the operation for any reason. The controller 140 may additionally provide safety warning messages to the user to ensure that the machine 100 and/or the screen assembly 104 are clear for movement prior to any actual engagement thereof. Once the machine 100 and/or screed assembly 104 has been engaged, the controller 140 may further be configured to automatically activate any one or more of the output devices 128 of the user interface 126 so as to alert and caution others within the vicinity of the machine 100 of active movement. For example, the controller 140 may activate the strobe light 132 to blink, activate speakers 134 to sound an audible alarm, activate the display screen 128 of the user interface 126 to blink, and/or activate any other peripheral of the machine 100 to signify active movement.

As in steps 144-8 and 144-9 discussed above with respect to job profiles 148, once the machine 100 and/or screed assembly 104 has been engaged to return to default settings and while auto-zeroing adjustments are being performed, the controller 140 may be configured to observe or monitor various positioning information collected by the one or more feedback devices 138 in step 144-12. More specifically, the controller 140 may observe the actual position, or actual progress of the adjustment, of any one or more components of the machine 100 and/or screed assembly 104 as detected by one or more of the feedback devices 138, and compare the actual position with the desired position, or the position corresponding to the auto-zero profile 150. The controller 140 may perform such comparisons per iteration for any number of cycles until a substantial agreement between the actual position and the desired position is found. If such a substantial agreement is observed between the actual position and the desired position, the controller 140 may be configured to disengage and end the adjustment of the one or more components of the paving machine 100 and/or screed assembly 104 in step 144-13. Moreover, by observing actual positioning feedback and using the feedback data as a reference, the controller 140 may be able to perform any number of adjustments to the machine 100 and/or screed assembly 104 in substantially less time and with increased accuracy.

In such a way, the present disclosure provides systems and methods which enable operators and users to generate and manage a library of different job profiles that is retrievably stored within a memory of the machine. Moreover, because each job profile is specifically optimized for a different type of jobsite or task, a user may be able to easily retrieve and set the control settings best suited for a new jobsite based on similarities between the new jobsite and the jobsites associated with the job profiles available. Furthermore, because the job profiles are locally stored in memory associated with the machine and easily accessible by anyone at any time, any number of different operators may alternatingly share the same machine without having to spend considerable downtime on machine setup. Still further, by providing an auto-zero/machine default profile that is always available, a user without particular familiarity with a given machine, or the job profiles stored thereon, is able to revert or restore the machine and/or the associated tools back to default or factory settings at any time. The present disclosure thus not only reduces the overall time required to setup, calibrate and operate the paving machine and/or screed assembly, but it also reduces operator errors and improves overall paving quality.

From the foregoing, it will be appreciated that while only certain embodiments have been set forth for the purposes of illustration, alternatives and modifications will be apparent from the above description to those skilled in the art. These and other alternatives are considered equivalents and within the spirit and scope of this disclosure and the appended claims.

What is claimed is:

1. A method of operating a paving machine having at least one tool, comprising the steps of:
storing one or more job profiles and an auto-zero profile in a memory associated with the paving machine, each of the job profiles and the auto-zero profile having one or more control settings for operating one or more of the paving machine and the tool;
recalling a selected one of the job profiles and the auto-zero profile in response to user input received at a user interface associated with the paving machine;
engaging operation of one or more of the paving machine and the tool according to the control settings associated with the selected one of the job profiles and the auto-zero profile; and
disengaging at least part of the operation based on positioning information provided by one or more feedback devices.

2. The method of claim 1, wherein one or more actuating devices are engaged to operate one or more of the paving machine and the tool, the actuating devices being disengaged based on the positioning information provided by the feedback devices.

3. The method of claim 1, wherein the feedback devices include any one or more of in-cylinder position sensors, linear variable displacement transducers, rotary sensors, switches, laser systems, sonic sensors, and radar, the positioning information being indicative of an actual position of one or more components of the paving machine and the tool as detected by the feedback devices, at least part of the operation being disengaged when the actual position is in substantial agreement with a desired position as determined by the selected one of the job profiles and the auto-zero profile.

4. The method of claim 1, wherein each job profile corresponds to a different one of a plurality of jobsites, the control settings of each job profile being configured for optimum operation of one or more of the paving machine and the tool for the corresponding jobsite, the control settings of the auto-zero profile being configured to reset the control settings to predefined default values.

5. The method of claim 1, further comprising the step of displaying the available job profiles and the auto-zero profile stored in the memory on a display device of the user interface through which any one or more of the control settings for any one or more of the job profiles are modifiable, any modified combination of the one or more control settings being stored in the memory as one of a new job profile and an overwritten one of the existing job profiles.

6. The method of claim 1, wherein the tool includes a screed assembly, the control settings relating to any one or more of screed height, screed width, conveyor mix height, auger mix height, auger height, tamper speed, tamper ramp rate, tamper speed ratio, vibrational frequency, pave speed, wheel assist mode, wheel assist pressure, screed assist mode, screed assist pressure, screed lower lock and halt modes, screed heat temperature, extender width, tow-point position, crown position, extender height, and extender slope.

7. A paving machine having a screed assembly, comprising:
a user interface;
one or more feedback devices coupled to one or more of the paving machine and the screed assembly; and
a controller in electrical communication with the user interface and the feedback devices, the controller being configured to store one or more job profiles in a memory associated with the paving machine, each of the job profiles having one or more control settings for operating one or more of the paving machine and the screed assembly, recall a selected one of the job profiles in response to user input received at the user interface associated with the paving machine, and engage operation of one or more of the paving machine and the screed assembly according to the control settings associated with the selected one of the job profiles.

8. The paving machine of claim 7, wherein the controller is configured to engage one or more actuating devices to operate one or more of the paving machine and the screed assembly, and disengage the actuating devices based on positioning information provided by the feedback devices.

9. The paving machine of claim 7, wherein the feedback devices include any one or more of in-cylinder position sensors, linear variable displacement transducers, rotary sensors, switches, laser systems, sonic sensors, and radar, the positioning information being indicative of an actual position of one or more components of the machine and the screed assembly as detected by the feedback devices, the controller being configured to disengage at least part of the operation when the actual position is in substantial agreement with a desired position as determined by the selected one of the job profiles and the auto-zero profile.

10. The paving machine of claim 7, wherein each job profile corresponds to a different one of a plurality of jobsites, the control settings of each job profile being configured for optimum operation of one or more of the machine and the screed assembly for the corresponding jobsite, the controller further being configured to store at least one auto-zero profile in the memory, the auto-zero profile being configured to reset the control settings to predefined default values.

11. The paving machine of claim 7, wherein the controller is configured to display the available job profiles on the display device of the user interface, enable user modification of any one or more of the control settings for any one or more of the job profiles, and store any modified combination of the one or more control settings in the memory as one of a new job profile and an overwritten one of the existing job profiles.

12. The paving machine of claim 7, wherein the controller is configured to modify control settings relating to any one or more of screed height, screed width, conveyor mix height, auger mix height, auger height, tamper speed, tamper ramp rate, tamper speed ratio, vibrational frequency, pave speed, wheel assist mode, wheel assist pressure, screed assist mode, screed assist pressure, screed lower lock and halt modes, screed heat temperature, extender width, tow-point position, crown position, extender height, and extender slope.

13. The paving machine of claim 7, wherein the user interface includes any one or more of monitors, screens, lighting devices, audible signals, touchscreens, touchpads, buttons, switches, buttons, dials, knobs, joysticks, and handles for facilitating user interaction.

14. A paving machine, comprising:
a screed assembly;
a user interface having at least one input device and at least one display device for operating the paving machine and the screed assembly;
one or more feedback devices coupled to the paving machine and the screed assembly configured to detect positioning information of one or more of the paving machine and the screed assembly;
a memory for retrievably storing one or more job profiles and an auto-zero profile, each of the job profiles and the auto-zero profile having one or more control settings for operating one or more of the paving machine and the screed assembly; and
a controller in electrical communication with each of the paving machine, the screed assembly, the user interface, the feedback devices, and the memory, the controller being configured to assign one or more of the control settings to one of the job profiles based on user input received through the input device of the user interface, recall a selected one of the job profiles and the auto-zero profile based on user input received through the input device of the user interface, engage operation of one or more of the paving machine and the screed assembly according to the control settings associated with the selected one of the job profiles and the auto-zero profile, and disengage at least part of the operation based on the positioning information provided by the feedback devices.

15. The paving machine of claim 14, further comprising one or more actuating devices configured to operate one or more of the paving machine and the screed assembly according to the control settings of the selected one of the job profiles and the auto-zero profile, the controller being configured to disengage the actuating devices based on the positioning information provided by the feedback devices.

16. The paving machine of claim 14, wherein the feedback devices include any one or more of in-cylinder position sensors, linear variable displacement transducers, rotary sensors, switches, laser systems, sonic sensors, and radar, the positioning information being indicative of an actual position of one or more components of the paving machine and the screed assembly as detected by the feedback devices, the controller being configured to disengage at least part of the operation when the actual position is in substantial agreement with a desired position as determined by the selected one of the job profiles and the auto-zero profile.

17. The paving machine of claim 14, wherein each job profile corresponds to a different one of a plurality of jobsites, the control settings of each job profile being configured for optimum operation of one or more of the paving machine and the screed assembly for the corresponding jobsite, the control settings of the auto-zero profile being configured to reset the control settings to predefined default values.

18. The paving machine of claim 14, wherein the controller is configured to display the available job profiles and the auto-zero profile on the display device of the user interface, enable user modification of any one or more of the control settings of any one or more of the job profiles, and store any modified combination of the one or more control settings in the memory as one of a new job profile and an overwritten one of the existing job profiles.

19. The paving machine of claim 14, wherein the controller is configured to modify control settings relating to any one or more of screed height, screed width, conveyor mix height, auger mix height, auger height, tamper speed, tamper ramp rate, tamper speed ratio, vibrational frequency, pave speed, wheel assist mode, wheel assist pressure, screed assist mode, screed assist pressure, screed lower lock and halt modes, screed heat temperature, extender width, tow-point position, crown position, extender height, and extender slope.

20. The paving machine of claim 14, wherein the user interface includes any one or more of monitors, screens, lighting devices, audible signals, touchscreens, touchpads, buttons, switches, buttons, dials, knobs, joysticks, and handles for facilitating user interaction.
